(19) United States
(12) Patent Application Publication
(10) Pub. No.: US 2026/0348722 A1
(43) Pub. Date: Nov. 5, 2026

(54) LASER PROFILE MEASUREMENT DEVICE

(71) Applicant: MITSUBISHI HEAVY INDUSTRIES, LTD., Tokyo (JP)

(72) Inventors: Ryuichi Narita, Tokyo (JP); Toshiya Watanabe, Tokyo (JP); Satoshi Tawara, Tokyo (JP)

(73) Assignee: MITSUBISHI HEAVY INDUSTRIES, LTD., Tokyo (JP)

(21) Appl. No.: 19/100,160

(22) PCT Filed: Oct. 6, 2023
(86) PCT No.: PCT/JP2023/036555

§ 371 Date: Jan. 31, 2025

(51) Int. Cl. G01B 11/24; B22F 12/90; B33Y 50/02; F28D 1/02

(52) U.S. Cl. CPC G01B 11/24; B22F 12/90; B33Y 50/02; F28D 1/02

(57) ABSTRACT

A laser profile measurement device includes: a reflection attenuation unit configured to generate, by transmitting at least part of a laser beam incident from a first direction, a measurement target laser beam traveling in the first direction, and configured to generate, by reflecting a remaining component of the laser beam in a second direction different from the first direction, a laser beam to be attenuated; a capture unit located on one side of the reflection attenuation unit in the first direction and configured to capture the measurement target laser beam; a casing extending in the first direction and covering the reflection attenuation unit and the capture unit from the outside; and an attenuation cooling body located on at least a portion of the casing in a circumferential direction when viewed from the first direction.

### TECHNICAL FIELD

The present disclosure relates to a laser profile measurement device.

### BACKGROUND ART

A three-dimensional additive manufacturing method called selective laser melting (SLM) is known. In this method, a process of applying heat by a laser beam to metal powder spread in a chamber to melt and harden the metal powder for each layer is repeated multiple times to obtain a desired object.

Here, in order to obtain a good object, it is necessary to precisely grasp and adjust a profile of the laser beam. The profile of the laser beam refers to a beam diameter and spatial intensity distribution of the laser beam. In the SLM manufacturing system, it is essential to directly measure the profile of the laser beam itself used for actual processing. Thus, it is necessary to place a measurement device in the chamber. One such measurement device described in Patent Document 1 below is known. The measurement device according to Patent Document 1 below mainly includes a device that attenuates a laser beam and a measurement unit that measures a profile of the attenuated laser beam.

### CITATION LIST

### Patent Literature

Patent Document 1: JP 6384589 B

### SUMMARY OF INVENTION

### Technical Problem

In the SLM manufacturing system, a rectangular processing region is set in the chamber. It is necessary to measure the laser profile not only in a central portion of the processing region but also in peripheral portions in a similar manner. However, the measurement device according to Patent Document 1 is not only large in size and dimension, but also can only measure a laser beam in one predetermined direction. Thus, there is a problem in that accurate laser profile measurement cannot be performed in the peripheral portions where the laser beam is emitted from a different direction and angle than in the central portion.

The present disclosure provides a laser profile measurement device that is smaller and capable of measuring a laser profile more accurately.

### Solution to Problem

A laser profile measurement device according to the present disclosure includes a reflection attenuation unit configured to generate, by transmitting at least part of a laser beam incident from a first direction, a measurement target laser beam traveling in the first direction, and configured to generate, by reflecting a remaining component of the laser beam in a second direction different from the first direction, a laser beam to be attenuated, a capture unit located on one side of the reflection attenuation unit in the first direction and configured to capture the measurement target laser beam, a casing extending in the first direction and covering the reflection attenuation unit and the capture unit from the outside, an attenuation cooling body located on at least a portion of the casing in a circumferential direction when viewed from the first direction, and a pivot support part configured to pivotally support the casing and the attenuation cooling body and orient the casing and the attenuation cooling body in an incident direction of the laser beam.

### Advantageous Effects of Invention

According to the present disclosure, it is possible to provide a laser profile measurement device that is smaller in size and capable of measuring a laser profile more accurately.

### BRIEF DESCRIPTION OF DRAWINGS

FIG. 1 is a schematic diagram illustrating an example of a configuration of a laser processing system according to a first embodiment of the present disclosure.

FIG. 2 is a plan view illustrating a configuration of a movement mechanism of a laser profile measurement device according to the first embodiment of the present disclosure.

FIG. 3 is an explanatory diagram illustrating a configuration of a pivot support part of the laser profile measurement device according to the first embodiment of the present disclosure.

FIG. 4 is a cross-sectional view illustrating a configuration of the laser profile measurement device according to the first embodiment of the present disclosure.

FIG. 5 is a plan view illustrating a configuration of an attenuation cooling body according to the first embodiment of the present disclosure.

FIG. 6 is a cross-sectional view illustrating the configuration of the attenuation cooling body according to the first embodiment of the present disclosure.

FIG. 7 is a view of horizontal split surfaces of the attenuation cooling body according to the first embodiment of the present disclosure, viewed from a second direction.

FIG. 8 is a view of the horizontal split surfaces of the attenuation cooling body according to the first embodiment of the present disclosure, viewed from a third direction.

FIG. 9 is a cross-sectional view illustrating a modification example of the attenuation cooling body according to the first embodiment of the present disclosure.

FIG. 10 is a cross-sectional view illustrating a configuration of an attenuation cooling body and a housing according to a second embodiment of the present disclosure.

### DESCRIPTION OF EMBODIMENTS

### First Embodiment

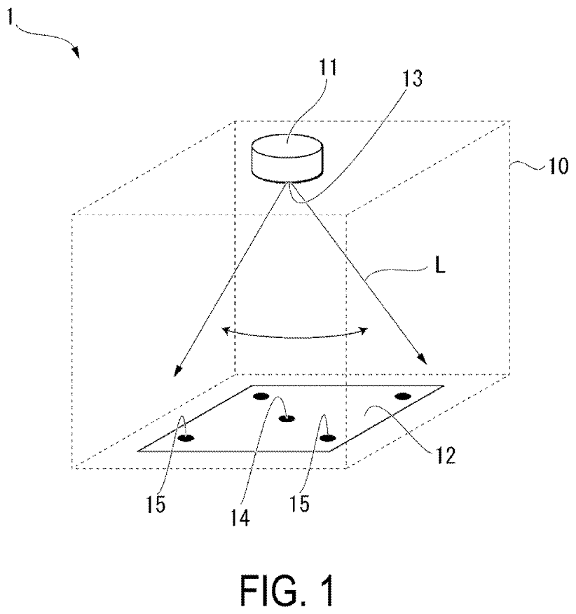

A laser processing system 1 and a laser profile measurement device 2 according to a first embodiment of the present disclosure will be described below with reference to FIGS. 1 to 8.

### Configuration of Laser Processing System

The laser processing system 1 according to the present embodiment is a manufacturing system that uses a three-dimensional additive manufacturing method called selective laser melting (SLM). In this method, a process of applying heat by a laser beam to metal powder spread in a chamber 10 to melt and harden the metal powder is repeated for multiple layers to obtain a desired object.

As illustrated in FIG. 1, the laser processing system 1 includes the chamber 10 and a laser irradiation unit 11. The chamber 10 has a box shape with a rectangular processing region 12 on an inner bottom surface thereof. The laser irradiation unit 11 emits and scans a laser beam L from an irradiation point 13 located above to the processing region 12. With metal powder supplied from a powder supply device (not illustrated), the laser beam L is emitted and scanned along a predetermined path to melt and harden the metal powder, thereby forming one layer of the object. This operation is repeated for multiple layers to form the object.

### Configuration of Laser Profile Measurement Device

In order to obtain a good object by the laser processing system 1, it is necessary to precisely grasp and adjust a profile of the laser beam L. The profile of the laser beam L refers to a beam diameter and spatial intensity distribution of the laser beam L. The laser profile measurement device 2 according to the present embodiment is used to measure such a profile of the laser beam L at a central portion 14 and peripheral portions 15 of the processing region 12. Note that the peripheral portions 15 here refer to corners and portions along sides of the rectangular processing region 12.

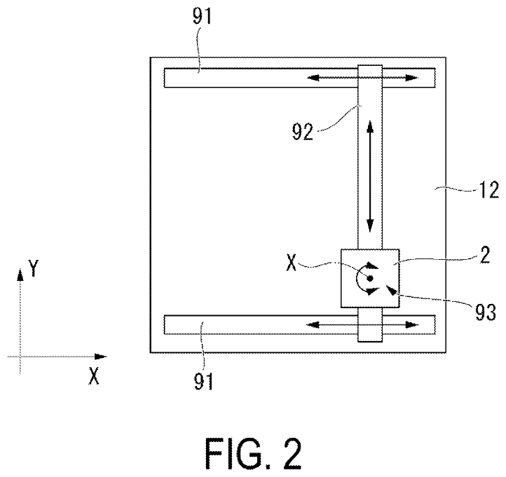

As illustrated in FIG. 2, a position of the laser profile measurement device 2 can be freely changed in an X-axis direction and a Y-axis direction within a plane of the processing region 12. To be specific, X-axis rails 91, a Y-axis rail 92, and a θ-axis pivot unit 93 are located in the processing region 12. The X-axis rails 91 move the laser profile measurement device 2 along the X-axis. The Y-axis rail 92 extends in a direction orthogonal to the X-axis, and is movable in the X-axis direction on the X-axis rails 91. The laser profile measurement device 2 is movable in the Y-axis direction on the Y-axis rail 92. The θ-axis pivot unit 93 supports the laser profile measurement device 2 so as to move pivotally about a pivot axis X extending in a vertical direction. It is desirable that operations by the X-axis rails 91, the Y-axis rail 92, and the θ-axis pivot unit 93 be autonomously controlled using an actuator and an encoder (not illustrated).

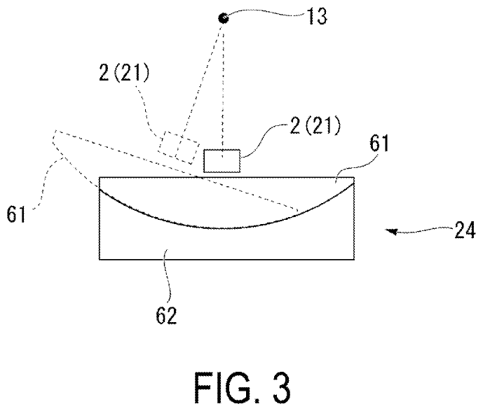

Further, as illustrated in FIG. 3, the laser profile measurement device 2 is supported from below by a pivot support part 24. The pivot support part 24 pivotally supports the laser profile measurement device 2 so as to face an incident direction of the laser beam L. In particular, an orientation of the laser profile measurement device 2 is changed so that a capture unit 21 (described later) of the laser profile measurement device 2, which captures the laser beam L, faces the incident direction of the laser beam L.

The pivot support part 24 includes a stage 61 on which the laser profile measurement device 2 is set and a support stand 62 that supports the stage 61 from below. A lower surface of the stage 61 protrudes in an arc surface shape. An upper surface of the support stand 62 is recessed in an arc surface shape corresponding to the lower surface of the stage 61. By pivoting the stage 61 along this arc surface, the stage 61 pivots around the pivot axis X extending in a horizontal direction. To be specific, a goniometer stage is suitably used as the pivot support part 24. The center of rotation of the pivot support part 24 is set so as to coincide with the irradiation point 13 of the laser beam L.

A position and an orientation of the laser profile measurement device 2 can be changed three-dimensionally by the X-axis rails 91, the Y-axis rail 92, the θ-axis pivot unit 93, and the pivot support part 24 as described above. Note that movement in a Z-axis direction orthogonal to the X-axis and the Y-axis is complemented by a function of moving the processing region 12 of the laser processing system 1 itself up and down. That is, the position and the orientation of the laser profile measurement device 2 can be changed in 5 axes and 10 directions.

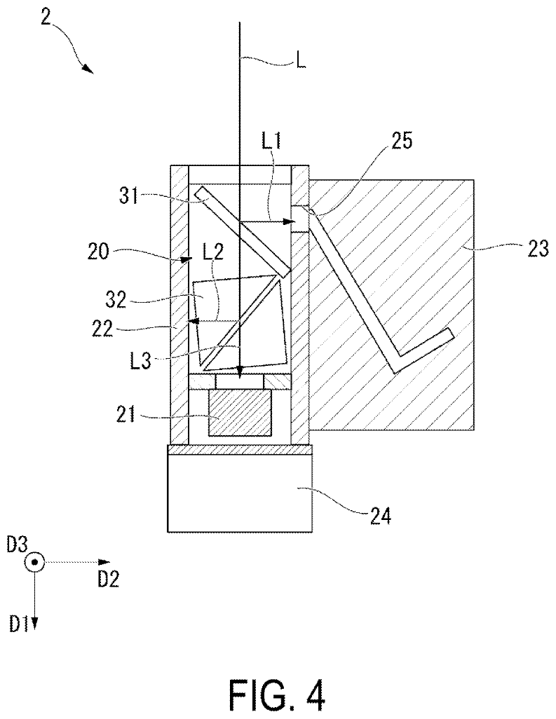

As illustrated in FIG. 4, the laser profile measurement device 2 includes a reflection attenuation unit 20, the capture unit 21, a casing 22, an attenuation cooling body 23, and the pivot support part 24 described above.

The reflection attenuation unit 20 reflects at least part of the incident laser beam L in a direction different from the incident direction and attenuates remaining unreflected components, thereby generating a measurement target laser beam L3. Here, the direction in which the laser beam L is incident is referred to as a first direction D1.

The reflection attenuation unit 20 includes a reflection attenuation element 31 and a near-field coupling element 32. The reflection attenuation element 31 is an optical element formed in a plate shape, and is positioned on a path of the laser beam L in a state inclined by about 45° relative to the first direction D1. The reflection attenuation element 31 reflects at least part of the incident laser beam L in a direction intersecting the first direction D1 by 90° (hereinafter, may be referred to as a second direction D2), thereby generating a first reflected beam L1 (a laser beam to be attenuated). Of all components of the laser beam L, remaining components except for the first reflected beam L1 travel in the first direction D1.

The near-field coupling element 32 is positioned on one side (below) of the reflection attenuation element 31 in the first direction D1. The near-field coupling element 32 is a known optical element, for example, as illustrated in WO 2017/209277. The near-field coupling element 32 is configured by placing two prisms to face each other with a gap therebetween. By generating and coupling near-field light between facing surfaces, a ratio of power of light emitted from the prism to power of light reflected by the prism.

In the present embodiment, when the laser beam L described above is incident on the near-field coupling element 32, some components of the laser beam L are reflected and travel in a direction different from the first direction D1 (second reflected beam L2). Remaining components of the laser beam L except for the second reflected beam L2 pass through the near-field coupling element 32 and travel in the first direction D1. The beam that passes through the reflection attenuation element 31 and the near-field coupling element 32 and travels in the first direction D1 is referred to as the measurement target laser beam L3. While output of the measurement target laser beam L3 is reduced compared to the laser beam L before the laser beam L is incident on the reflection attenuation element 31, a beam diameter and spatial intensity distribution are similar to those of the laser beam L before the laser beam L is incident on the reflection attenuation element 31.

The capture unit 21 is located below the reflection attenuation unit 20 (on one side in the first direction D1). The capture unit 21 is, for example, a CCD camera. The capture unit 21 captures the measurement target laser beam L3 and transmits the captured measurement target laser beam L3 as image data to an external arithmetic device or the like. Through calculation in the arithmetic device, a laser profile of the measurement target laser beam L3 is obtained.

The reflection attenuation unit 20 and the capture unit 21 described above are covered with the casing 22 from the outside. The casing 22 is a cylindrical body having a rectangular, polygonal, or circular shape when viewed from the first direction D1. An upper portion of the casing 22 is open to allow the laser beam L to enter. An opening 25 is formed in a portion of the casing 22 in a circumferential direction for transmitting the first reflected beam L1. That is, the opening 25 is formed at a position overlapping the reflection attenuation unit 20 in the first direction D1. The opening 25 is formed at a position that coincides with an irradiation direction of the first reflected beam L1 in the circumferential direction relative to the first direction D1. The opening 25 passes through the casing 22 in a radial direction relative to the first direction D1.

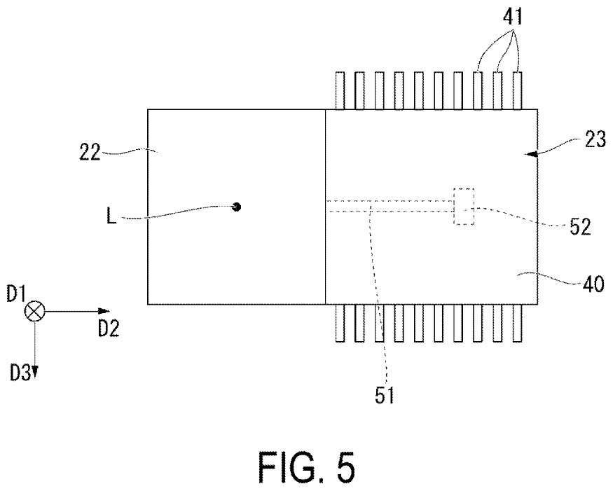

The attenuation cooling body 23 is located to attenuate the first reflected beam L1 described above while dissipating thermal energy thereof to the outside. As illustrated in FIG. 5, the attenuation cooling body 23 is concentrated on only a portion of the outside surface of the casing 22 in the circumferential direction in the first direction D1 when viewed from the first direction D1. That is, when the casing 22 has a rectangular shape or a polygonal shape, the attenuation cooling body 23 is attached to only one specific surface. In the example in FIG. 5, for the sake of simplicity, an example is illustrated in which the casing 22 has a rectangular cross section.

Note that the attenuation cooling body 23 need only be located in at least a portion of the casing 22 in the circumferential direction in the first direction D1.

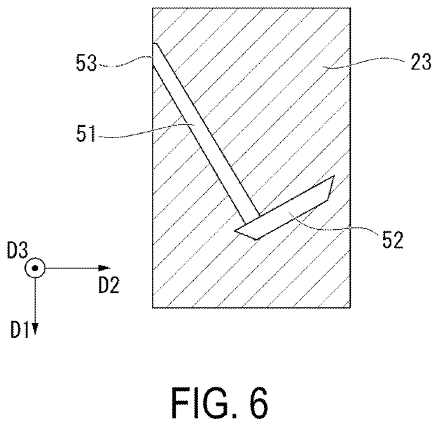

The attenuation cooling body 23 includes a cooling body main body 40 and multiple fins 41. The multiple fins 41 are arranged on the outer surfaces of the cooling body main body 40 so as to extend in the first direction D1 and be spaced apart from each other in the second direction D2. As illustrated in FIG. 6, inside the cooling body main body 40, a first attenuation passage 51 and a second attenuation space 52 for attenuating the first reflected beam L1 are formed. An inlet side end 53 of the first attenuation passage 51 communicates with the opening 25 in the casing 22 described above. Preferably, the first attenuation passage 51 extends in a direction intersecting the second direction D2, which is the traveling direction of the first reflected beam L1, in a range of 45° to 70°. Note that the direction in which the first attenuation passage 51 extends can be appropriately changed in accordance with design and specifications. Although not illustrated in detail, in a section of the first attenuation passage 51, including the inlet side end 53, an inner wall is mirror-finished. In a remaining section, the inner wall is coated with black paint.

The second attenuation space 52 communicates with the first attenuation passage 51 and extends in a direction intersecting the first attenuation passage 51. More preferably, the second attenuation space 52 extends in a direction orthogonal to the first attenuation passage 51. When viewed from a third direction D3 orthogonal to the first direction D1 and the second direction D2, the second attenuation space 52 has a trapezoidal cross-sectional shape. This is due to machining reasons. Therefore, when the processing method permits, the second attenuation space 52 may have a rectangular cross-sectional shape. The first reflected beam L1 incident on the first attenuation passage 51 and the second attenuation space 52 is attenuated while repeating multiple reflections between the inner wall surfaces. Thermal energy of the first reflected beam L1 is absorbed by the cooling body main body 40. The absorbed heat is dissipated to the outside through the fins 41 and the outer surface of the cooling body main body 40.

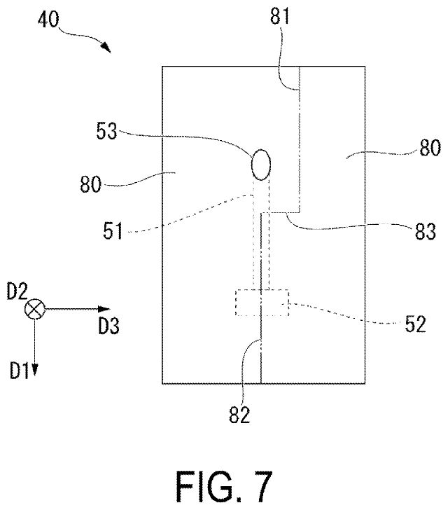

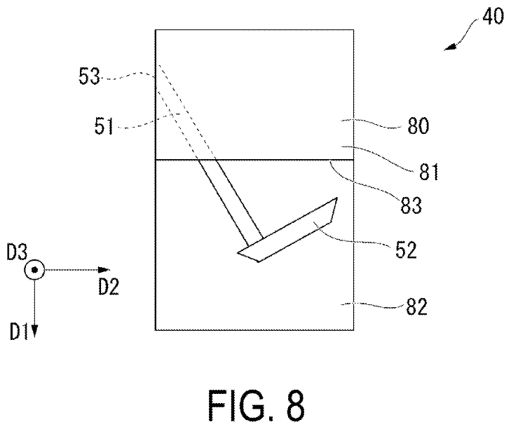

Next, a detailed configuration of the cooling body main body 40 will be described with reference to FIGS. 7 and 8. The cooling body main body 40 is composed of a pair of segments 80. The segments 80 are partitioned by a first horizontal split surface 81, a second horizontal split surface 82, and a connection horizontal split surface 83. As illustrated in FIG. 7, the first horizontal split surface 81 passes through a surface different from the inlet side end 53 of the first attenuation passage 51 when viewed from the second direction D2. That is, in a region including the inlet side end 53, the first attenuation passage 51 is formed as a tubular passage having a continuous inner wall surface.

On the other hand, the second horizontal split surface 82 splits the second attenuation space 52 into two when viewed from the second direction D2. That is, when viewed from the second direction D2, the first horizontal split surface 81 and the second horizontal split surface 82 are at different positions in the third direction D3. The connection horizontal split surface 83 connects the first horizontal split surface 81 and the second horizontal split surface 82 in the third direction D3. Therefore, as illustrated in FIG. 8, in one segment 80, recesses that are part of the first attenuation passage 51 except on the inlet side end 53 side and part of the second attenuation space 52 are exposed. The black paint described above is applied to these exposed portions.

### Operational Effects

When using the laser profile measurement device 2, first, the laser profile measurement device 2 is placed in the processing region 12 of the laser processing system 1. At this time, the X-axis rails 91, the Y-axis rail 92, and the θ-axis pivot unit 93 described above are set in advance, and then the laser profile measurement device 2 is set on the Y-axis rail 92. Thereafter, the laser profile is measured at various points in the processing region 12 while automatically changing the laser profile measurement device 2 to various positions and orientations.

In the SLM manufacturing system, it is necessary to measure the laser profile not only in the central portion 14 of the processing region 12 but also in the peripheral portions 15 in a similar manner. However, the known measurement device is not only large in size and dimension, but also can only measure a laser beam in one predetermined direction. Thus, there is a problem in that accurate laser profile measurement cannot be performed in the peripheral portions 15 where the laser beam is emitted from a different direction and angle than in the central portion 14. Thus, in the present embodiment, each configuration described above is adopted.

According to the above configuration, an attenuation cooling unit is located only on a portion of the casing 22 in the circumferential direction. In the peripheral portions 15 in the processing region 12, by changing the orientation of the attenuation cooling unit so that the attenuation cooling unit is positioned on an opposite side to the inner wall of the processing region 12, interference between the inner wall and the attenuation cooling body 23 is eliminated. Thus, the laser profile measurement device 2 (the casing 22 itself) can be brought close to the vicinity of the inner wall. As a result, the laser profile can be accurately measured over a wider range including the peripheral portions 15. This leads to improved processing accuracy of the final product.

Further, according to the above configuration, the laser beam is attenuated by multiple reflections in the first attenuation passage 51 and the second attenuation space 52. In particular, since the first attenuation passage 51 extends in a direction intersecting the second direction D2, when a laser beam is incident on the first attenuation passage 51, the laser beam (first reflected beam L1) is incident on the inner wall of the first attenuation passage 51 in a range in which the laser beam can be reflected. Thus, the path for multiple reflections can be easily formed without using any other device for changing the path of the first reflected beam L1. As a result, the manufacturing and operating costs of the device can be reduced. In addition, the number of components of the device can be reduced and the size and dimension of the device can be reduced.

According to the above configuration, when manufacturing the attenuation cooling body 23, by forming recesses in both of the segments 80 split by the second horizontal split surface 82 and then combining the segments 80, the second attenuation space 52 can be easily formed. On the other hand, the first horizontal split surface 81 passes through a surface different from the first attenuation passage 51. As a result, the section including the inlet side end 53 of the first attenuation passage 51 has a continuous tubular shape with no seams. That is, no discontinuous horizontal split lines are generated on the inner wall surface of the first attenuation passage 51. Therefore, diffusion of the laser beam at the inlet side end 53, where the high-intensity laser beam enters immediately after reflection, can be prevented, and reflection of the laser beam in an unexpected path can be prevented. As a result, the laser profile measurement device 2 can be operated more stably.

Furthermore, according to the above configuration, the laser beam that has passed through the first attenuation passage 51 is further greatly attenuated when the laser beam enters the second attenuation space 52 that intersects the first attenuation passage 51. Thus, a path length for attenuating the laser beam can be shortened. As a result, the size and dimension of the attenuation cooling body 23 can be further reduced. On the other hand, when only the first attenuation passage 51 is included, the laser beam needs to be attenuated in a linear path, which increases the path length and may result in an increase in size of the device. According to the above configuration, such a possibility can be avoided.

According to the above configuration, the fins 41 are located on the cooling body main body 40, which makes it possible to increase the contact area with the outside by the surface area of the fins 41. Accordingly, the heat in the cooling body main body 40 can be easily dissipated to the outside.

Therefore, the laser profile measurement device 2 can be operated continuously and more stably for a long time.

The first embodiment of the present disclosure has been described above. Note that various changes and modifications can be made to the above-described configurations without departing from the gist of the present disclosure.

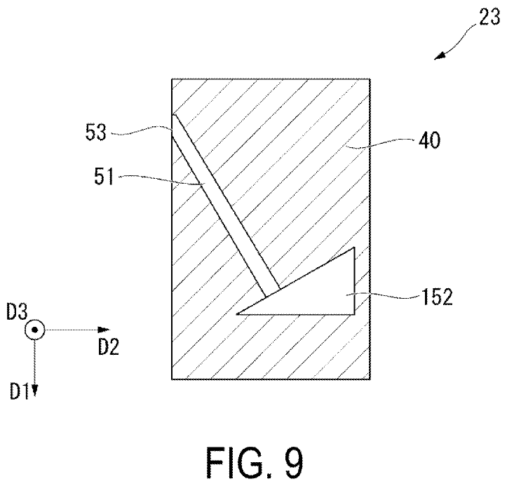

For example, as illustrated in FIG. 9 as a modification example, a cross-sectional shape of a second attenuation space 152 can be changed. In the example in this figure, the second attenuation space 152 has a right-angled triangular shape when viewed from the third direction D3. An end of the first attenuation passage 51 is positioned on a hypotenuse of the second attenuation space 152. A bottom side extends in the second direction D2. According to this configuration, multiple reflection of a laser beam that has passed through the first attenuation passage 51 is repeated in the second attenuation space 152 that has a right-angled triangular shape, and is finally attenuated more greatly. Thus, the measurement target laser beam L3 can be extracted accurately and stably. As a result, the laser profile can be measured stably.

### Second Embodiment

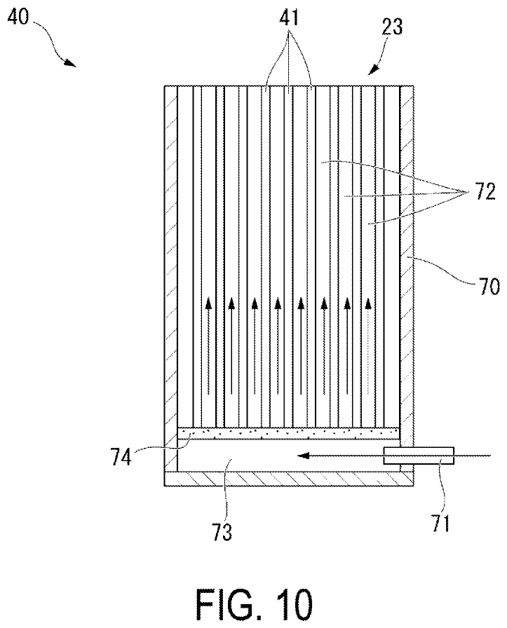

Next, a second embodiment of the present disclosure will be described with reference to FIG. 10. Note that the same components as those of the first embodiment will be denoted by the same reference signs, and a detailed description thereof will be omitted. As illustrated in FIG. 10, a laser profile measurement device 2 according to the present embodiment further includes a housing 70 that covers an attenuation cooling body 23 from the outside, and a gas supply unit 71 that supplies a refrigerant gas into the housing 70.

The housing 70 accommodates the attenuation cooling body 23 therein, and has an opening formed at the top. By being covered with the housing 70 from the outside, multiple refrigerant flow paths 72 extending in a first direction D1 are formed between fins 41. A space 73 is formed between a lower surface of the attenuation cooling body 23 and a bottom surface of the housing 70. A sintered metal board 74 is attached to an upper surface of the space 73. The gas supply unit 71 supplies the refrigerant gas to the refrigerant flow paths 72 through the space 73. As the refrigerant gas, argon is preferably used, which is supplied as an atmospheric gas into a processing region 12 of a laser processing system 1. That is, the gas supply unit 71 is connected to a supply source of this argon.

According to the above configuration, the attenuation cooling body 23 can be cooled more efficiently and stably by the refrigerant gas flowing through the refrigerant flow paths. Further, the argon used in laser processing is used as the refrigerant gas, so there is no need to install another gas supply source. This also allows for a significant reduction in operating costs.

The second embodiment of the present disclosure has been described above. Note that various changes and modifications can be made to the above-described configurations without departing from the gist of the present disclosure.

### Supplementary Notes The laser profile measurement devices 2 according to the embodiments are understood, for example, as follows.

(1) A laser profile measurement device 2 according to a first aspect includes a reflection attenuation unit 20 configured to generate, by transmitting at least part of a laser beam incident from a first direction D1, a measurement target laser beam traveling in the first direction D1, and configured to generate, by reflecting a remaining component of the laser beam in a second direction D2 different from the first direction D1, a laser beam to be attenuated, a capture unit 21 located on one side of the reflection attenuation unit 20 in the first direction D1 and configured to capture the measurement target laser beam, a casing 22 extending in the first direction D1 and covering the reflection attenuation unit 20 and the capture unit 21 from the outside, an attenuation cooling body 23 located on at least a portion of the casing 22 in a circumferential direction when viewed from the first direction D1, and a pivot support part 24 configured to pivotally support the casing 22 and the attenuation cooling body 23 and orient the casing 22 and the attenuation cooling body 23 in an incident direction of the laser beam.

According to the above configuration, the attenuation cooling unit is located on at least a portion of the casing 22 in the circumferential direction. Accordingly, in the peripheral portions 15 in the processing region 12 of the SLM manufacturing system, by changing the orientation of the attenuation cooling unit so that the attenuation cooling unit is positioned on an opposite side to the inner wall of the processing region 12, the laser profile measurement device 2 can be brought close to the vicinity of the inner wall. This makes it possible to accurately measure the laser profile over a wider range.
(2) A laser profile measurement device 2 according to a second aspect is the laser profile measurement device 2 according to (1), in which the attenuation cooling body 23 includes a first attenuation passage 51 extending in a direction intersecting the second direction D2 and configured to multiply reflect the laser beam to be attenuated, and a second attenuation space 52 communicating with the first attenuation passage 51.

According to the above configuration, the laser beam is attenuated by multiple reflections in the first attenuation passage 51 and the second attenuation space 52. In particular, since the first attenuation passage 51 extends in the direction intersecting the second direction D2, the multi-reflection path can be easily formed by the laser beam being incident on the first attenuation passage 51.
(3) A laser profile measurement device 2 according to a third aspect is the laser profile measurement device 2 according to (2), in which the attenuation cooling body 23 includes segments 80 split by a first horizontal split surface 81 passing through a surface different from an inlet side end 53 of the first attenuation passage 51 when viewed from the second direction D2, a second horizontal split surface 82 splitting the second attenuation space 52 when viewed from the second direction D2, and a connection horizontal split surface 83 connecting the first horizontal split surface 81 and the second horizontal split surface 82.

According to the above configuration, when manufacturing the attenuation cooling body 23, by forming recesses in both of the segments 80 split by the second horizontal split surface 82 and then combining the segments 80, the second attenuation space 52 can be easily formed. On the other hand, the first horizontal split surface 81 passes through a surface different from the first attenuation passage 51. Thus, no discontinuous horizontal split lines are generated on the inner wall surface of the first attenuation passage 51. Therefore, diffusion of the laser beam in the first attenuation passage 51, where the high-intensity laser beam enters immediately after reflection, can be prevented, and reflection of the laser beam in an unexpected path can be prevented.
(4) A laser profile measurement device 2 according to a fourth aspect is the laser profile measurement device 2 according to (2) or (3), in which the second attenuation space 52 extends in a direction intersecting the first attenuation passage 51.

According to the above configuration, the laser beam that has passed through the first attenuation passage 51 is further greatly attenuated when the laser beam enters the second attenuation space 52 that intersects the first attenuation passage 51. Thus, since a path length can be shortened, the size and dimension of the attenuation cooling body 23 can be kept small.
(5) A laser profile measurement device 2 according to a fifth aspect is the laser profile measurement device 2 according to (2) or (3), in which the second attenuation space 52 has a triangular cross-sectional shape having an oblique side orthogonal to a direction in which the first attenuation passage 51 extends and a bottom side extending in the second direction D2, when viewed from a direction orthogonal to the first direction D1 and the second direction D2.

According to the above configuration, multiple reflection of the laser beam that has passed through the first attenuation passage 51 is repeated in the second attenuation space 52 that has a triangular shape, and is finally attenuated greatly. Thus, the measurement target laser beam can be extracted accurately and stably. As a result, the laser profile can be measured stably.
(6) A laser profile measurement device 2 according to a sixth aspect is the laser profile measurement device 2 according to any one of (2) to (5), in which the attenuation cooling body 23 includes a cooling body main body 40 having the first attenuation passage 51 and the second attenuation space 52, and multiple fins 41 located on an outer surface of the cooling body main body 40.

According to the above configuration, the fins 41 are located on the cooling body main body 40, which makes it possible to increase the contact area with the outside. Accordingly, the heat in the cooling body main body 40 can be easily dissipated to the outside.
(7) A laser profile measurement device 2 according to a seventh aspect is the laser profile measurement device 2 according to any one of (1) to (6), and further includes a housing 70 configured to accommodate the attenuation cooling body 23 and form a refrigerant flow path 72 in the housing 70, and a gas supply unit 71 configured to supply a refrigerant gas to the refrigerant flow path 72.

According to the above configuration, the attenuation cooling body 23 can be cooled more efficiently and stably by the refrigerant gas flowing through the refrigerant flow path 72. Further, a cooling mechanism can be completed inside the chamber 10, eliminating the need for wiring such as hoses to the outside of the chamber 10, thereby simplifying the overall configuration of the system.

### INDUSTRIAL APPLICABILITY

According to the present disclosure, it is possible to provide a laser profile measurement device that is smaller in size and capable of measuring a laser profile more accurately.

### REFERENCE SIGNS LIST

1 Laser processing system
2 Laser profile measurement device
10 Chamber
11 Laser irradiation unit
12 Processing region
13 Irradiation point
14 Central portion
15 Peripheral portion
20 Reflection attenuation unit
21 Capture unit
22 Casing
23 Attenuation cooling body
24 Pivot support part
25 Opening
31 Reflection attenuation element
32 Near-field coupling element
40 Cooling body main body
41 Fin
51 First attenuation passage
52 Second attenuation space
53 Inlet side end
61 Stage
62 Support stand
70 Housing
71 Gas supply unit
72 Refrigerant flow path
73 Space
74 Board
80 Segment
81 First horizontal split surface
82 Second horizontal split surface
83 Connection horizontal split surface
91 X-axis rail
92 Y-axis rail
93 θ-axis pivot unit
152 Second attenuation space
D1 First direction
D2 Second direction
D3 Third direction
L Laser beam
L1 First reflected beam
L2 Second reflected beam
L3 Measurement target laser beam
X Pivot axis

1. A laser profile measurement device comprising:
a reflection attenuation unit configured to generate, by transmitting at least part of a laser beam incident from a first direction, a measurement target laser beam traveling in the first direction, and configured to generate, by reflecting a remaining component of the laser beam in a second direction different from the first direction, a laser beam to be attenuated;
a capture unit located on one side of the reflection attenuation unit in the first direction and configured to capture the measurement target laser beam;
a casing extending in the first direction and covering the reflection attenuation unit and the capture unit from the outside;
an attenuation cooling body located on at least a portion of the casing in a circumferential direction when viewed from the first direction; and
a pivot support part configured to pivotally support the casing and the attenuation cooling body and orient the casing and the attenuation cooling body in an incident direction of the laser beam, wherein
the attenuation cooling body includes:
a first attenuation passage extending in a direction intersecting the second direction and configured to multiply-reflect the laser beam to be attenuated,
a second attenuation space communicating with the first attenuation passage, and
segments split by a first horizontal split surface passing through a surface different from an inlet side end of the first attenuation passage when viewed from the second direction, a second horizontal split surface splitting the second attenuation space when viewed from the second direction, and a connection horizontal split surface connecting the first horizontal split surface and the second horizontal split surface.

2.-3. (canceled)

4. The laser profile measurement device according to claim 1, wherein the second attenuation space extends in a direction intersecting the first attenuation passage.

5. The laser profile measurement device according to claim 1, wherein the second attenuation space has a triangular cross-sectional shape having an oblique side orthogonal to a direction in which the first attenuation passage extends and a bottom side extending in the second direction, when viewed from a direction orthogonal to the first direction and the second direction.

6. The laser profile measurement device according to claim 1, wherein
the attenuation cooling body includes:
a cooling body main body having the first attenuation passage and the second attenuation space, and
a plurality of fins located on an outer surface of the cooling body main body.

7. The laser profile measurement device according to claim 1, further comprising:
a housing configured to accommodate the attenuation cooling body and form a refrigerant flow path in the housing; and
a gas supply unit configured to supply a refrigerant gas to the refrigerant flow path.
